(19) United States
(12) Patent Application Publication
(10) Pub. No.: US 2014/0185221 A1
(43) Pub. Date: Jul. 3, 2014

(54) COMPUTER SYSTEM WITH DISPLAY

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: MENG-LIANG YANG, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/135,700

(22) Filed: Dec. 20, 2013

(30) Foreign Application Priority Data
Dec. 28, 2012 (CN) 2012105784783

(51) Int. Cl. G06F 1/16

(52) U.S. Cl. CPC G06F 1/16
USPC 361/679.21

(57) ABSTRACT

A computer system includes a host and a display. The host includes a first video graphics array (VGA) connector. The display includes a second VGA connector and a power supply circuit coupled to the second VGA connector. The second VGA connector is connected to the first VGA connector to acquire power from the first VGA connector.

### BACKGROUND

1. Technical Field

The present disclosure relates to a computer system comprising a display.

2. Description of Related Art

Most computer system includes a motherboard enclosed in a case and a display. However, the central processing unit (CPU) unit and the display are connected to an external power source through different wires, which is inconvenient.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a computer system of the present disclosure, wherein the computer system includes a first video graphics array (VGA) connector.

FIG. 2 is a circuit diagram of the first VGA connector of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

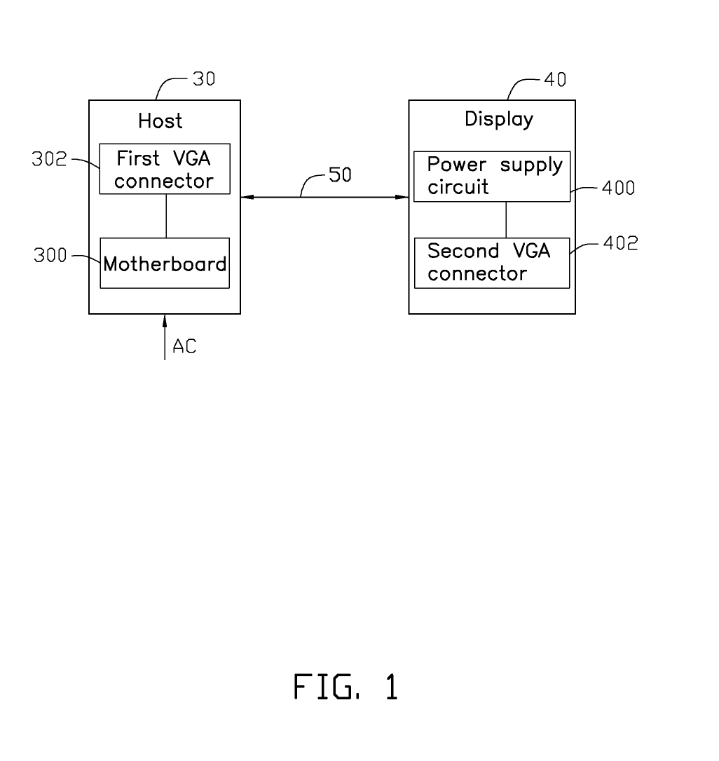

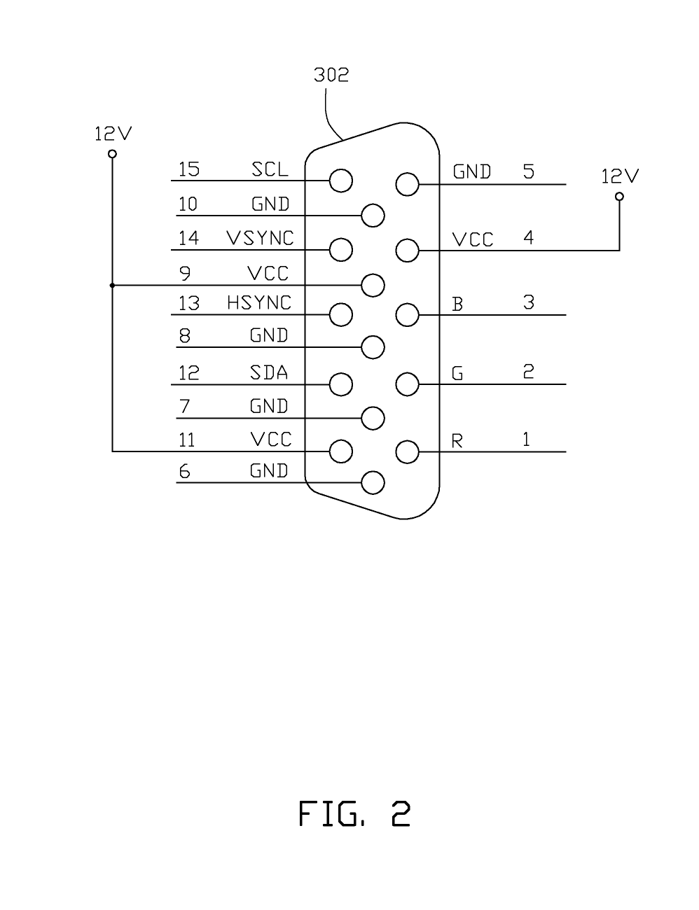

FIGS. 1 and 2 illustrate an embodiment of a computer system of the present disclosure. The computer system comprises a host 30 and a display 40.

The host 30 includes a first video graphics array (VGA) connector 302 and a motherboard 300. The motherboard 300 is connected to an external power source, such as an alternating current (AC) power source. The motherboard 300 outputs various voltages to other components arranged on the motherboard 300. The first VGA connector 302 is located on the motherboard 300 and outputs image signals.

In one embodiment, the first VGA connector 302 comprises first to fifteenth pins 1-15. The first VGA connector 302 has the same number of pins as a conventional VGA connector, except for the fourth, ninth, and eleventh pins 4, 9, and 11. The fourth, ninth, and eleventh pins 4, 9, and 11 are connected to the motherboard 300 to receive a voltage supplied by the motherboard 300.

The display 40 includes a second VGA connector 402 and a power supply circuit 400. First to fifteenth pins of the second VGA connector 402 are connected to the first to fifteenth pins of the first VGA connector 302, respectively, through a wire 50. The fourth, ninth, and eleventh pins 4, 9, and 11 of the second VGA connector 402 are connected to the power supply circuit 400, thereby powering the display 40. Accordingly, the display 40 can acquire power from the host 30 directly.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A computer system, comprising:
a host comprising a motherboard and a first video graphics array (VGA) connector, wherein the first VGA connector comprises first to fifteenth pins, the fourth, ninth, and eleventh pins of the first VGA connector are connected to the motherboard to acquire power from the motherboard; and
a display comprising a second VGA connector and a power supply circuit, wherein the second VGA connector comprises first to fifteenth pins, the first to fifteenth pins of the second VGA connector are connected to the first to fifteenth pins of the first VGA connector, respectively, through wires, and the fourth, ninth, and eleventh pins of the second VGA connector are connected to the power supply circuit, to acquire power from the first VGA connector.
